(19) United States
(12) Patent Application Publication
(10) Pub. No.: US 2017/0069159 A1
(43) Pub. Date: Mar. 9, 2017

(54) ANALYTICS SYSTEM AND METHOD

(71) Applicant: MuSigma Business Solutions Pvt. Ltd., Whitefield Road, Bangaluru (IN)

(72) Inventors: Gopi B. Vikranth, Austin, TX (US); Zubin Dowalty, Georgetown, TN (US); Ankit Chandra, Austin, TX (US); Subir Mansukhani, Bengaluru (IN); Bharat Upadrasta, Bangalore (IN); Mayukh Bose, Bengaluru (IN); Ummadisingu Avinash, Bengaluru (IN)

(21) Appl. No.: 14/995,259

(22) Filed: Jan. 14, 2016

(30) Foreign Application Priority Data
Sep. 4, 2015 (IN) 4690/CHE/2015

(51) Int. Cl. G07F 17/32

(52) U.S. Cl. CPC G07F 17/3206; G07F 17/3293; G07F 17/3248; G07F 17/3272; G07F 17/3237

(57) ABSTRACT

An analytics systems adapted for use in a real-time gaming environment is provided. The analytics system includes a plurality of gaming stations disposed in a plurality of locations within the gaming environment. Each gaming station includes a display zone for displaying a plurality of gaming objects. The analytics system includes at least one sensor configured to capture object data corresponding to the plurality of gaming objects displayed in the display zone. In addition, the analytics system includes at least one processor coupled to the sensor and configured to generate identification data for the plurality of gaming objects. Moreover, the analytics system also includes a multi-agent based system. Lastly, the analytics system includes a monitoring module coupled to the multi-agent based system and configured to enable a user to monitor a plurality of events occurring at each gaming station.

### PRIORITY STATEMENT

The present application hereby claims priority under 35 U.S.C. §119 to Indian patent application number 4690/CHE/2015 filed Sep. 4, 2015, the entire contents of which are hereby incorporated herein by reference.

### FIELD

At least one embodiment of the invention relates generally to analytics systems and more particularly to a system and method for managing customer interactions by using proximate objects interconnected over a network.

### BACKGROUND

Typically, in an organization, quick business decisions play a vital role for the growth of the organization. Currently, business decisions are inefficient due to lack of accurate data. In present systems accurate data collection modules increase the cost of implementation. In addition, the data collection and data consumption techniques have a latency period, resulting in delayed business decisions. Business decisions are typically reliant on the quality and the speed at which data is captured and made available.

Currently, organizations use manual interventions to capture data. After the data has been manually captured, decision making is done either manually, or data is fed into a traditional EDW/Big Data store, which provides an after-the-fact insight into the business operations. For example, retailers today are paralyzed by the rate of data flowing into the enterprise and the vast array of sources, data types, data combinations, from which insights and decisions are generated. Automating the capturing and collection process of data in a natural retail environment produces more consistent, quantified, and accurate data, reducing variation and errors from manual observation and point-of-view reporting.

In another example, in casinos, the capture of real-time data from gaming tables like Blackjack, Poker or Baccarat is vital. It is often desirable to collect the real-time data with minimal latency period, so that business insights are generated in real-time. The business insights are then provided to the floor manager who can then respond to dynamic needs of the business like changing number of open gaming tables, changing the distribution of different types of games on the floor, improving dealer efficiency etc.

### SUMMARY

The inventors have recognized a need for a system and method to automate the process of capturing, collecting and transmitting the data of real-time events across organizations.

Briefly, according to one embodiment of the invention, an analytics systems adapted for use in a real-time gaming environment is provided. The analytics system includes a plurality of gaming stations disposed in a plurality of locations within the gaming environment. Each gaming station includes a display zone for displaying a plurality of gaming objects. The analytics system includes at least one sensor configured to capture object data corresponding to the plurality of gaming objects displayed in the display zone. In addition, the analytics system includes at least one processor coupled to the sensor and configured to generate identification data for the plurality of gaming objects. Moreover, the analytics system also includes a multi-agent based system. The multi-agent based system includes a core engine configured to define and deploy a plurality of agents. The plurality of agents are configured to perform a set of programmable tasks defined by one or more users. The set of programmable tasks are configured to operate with the object data. The multi-agent based system also includes a monitoring engine configured to monitor a lifecycle of the plurality of agents, communication amongst the plurality of agents and a processing time of the programmable tasks. In addition, the multi-agent based system includes a computing engine coupled to the core engine and configured to execute the set of programmable tasks. Lastly, the analytics system includes a monitoring module coupled to the multi-agent based system and configured to enable a user to monitor a plurality of events occurring at each gaming station.

Briefly, according to yet one embodiment of the invention, an internet of things based analytics systems for improving customer experience is provided. The analytics system includes a plurality of articles of interest disposed in a plurality of locations within an establishment. Moreover, the analytics system includes at least one sensor configured to capture image data corresponding to the plurality of articles of interest. The analytics system includes at least one processor coupled to the sensor and configured to generate identification data for the plurality of articles of interest. The analytics system includes a multi-agent based system. The multi-agent based system includes a core engine configured to define and deploy a plurality of agents. The plurality of agents are configured to perform a set of programmable tasks defined by one or more users. The set of programmable tasks are configured to operate with the object data. The multi-agent based system includes a monitoring engine configured to monitor a lifecycle of the plurality of agents, communication amongst the plurality of agents and a processing time of the programmable tasks. Also, the multi-agent based system includes a computing engine coupled to the core engine and configured to execute the set of programmable tasks. Lastly, the analytics system includes a monitoring module coupled to the multi-agent based system and configured to enable a user to monitor a plurality of business parameters for the plurality of articles of interest.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of one embodiment of an internet of things based analytics system implemented according to aspects of the present technique;

FIG. 2 is an example configuration of one embodiment of an internet of things based analytics system adapted for use in real-time gaming environment implemented according to aspects of the present technique;

FIG. 3 is a flow chart illustrating one embodiment of a method by which the gaming object such as ‘playing card’ is identified according to aspects of the present techniques;

FIG. 4 is a flow chart illustrating one embodiment of a method by which the gaming object such as ‘chip’ is identified according to aspects of the present techniques;

FIG. 5 is a flow chart illustrating one embodiment of a method by which a wide variety of business data is captured, enabled for real-time decision making based on machine learning and statistical techniques according to aspects of the present techniques; and

FIG. 6 is a flow chart illustrating one embodiment of a method by which real-time data about product availability from a retail outlet is captured and analyzed, according to aspects of the present techniques.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one embodiment of the present invention provides an Internet of Things (IoT) based analytics system configured to adapt for use in an environment serving several customers. More particularly, at least one embodiment of the invention provides an analytics system for understanding and improving customer experience. The Internet of Things (IoT), also referred as Internet of Everything is the network of physical objects or “things” embedded with electronics, software, sensors, and connectivity to enable objects to exchange data with the manufacturer, operator and/or other connected devices based on the infrastructure of International Telecommunication Union's Global Standards Initiative. In particular, the Internet of Things allows objects to be sensed and controlled remotely across existing network infrastructure, creating opportunities for more direct integration between the physical world and computer-based systems, and resulting in improved efficiency, accuracy and economic benefit. Each thing is uniquely identifiable through its embedded computing system and is able to interoperate within the existing Internet infrastructure.

The internet of things based analytics systems and methods are described with example embodiments and drawings. References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The IoT based analytics system disclosed herein enables end-to-end capability including capturing of real-time data and recommending various scenarios to make accurate business decisions. Moreover, the IoT based analytics system captures a wide variety of business data, enables near-real time decision making based on machine learning and statistical techniques, and integrates it with customized visualization components to enable the end user to make quick and effective business decisions.

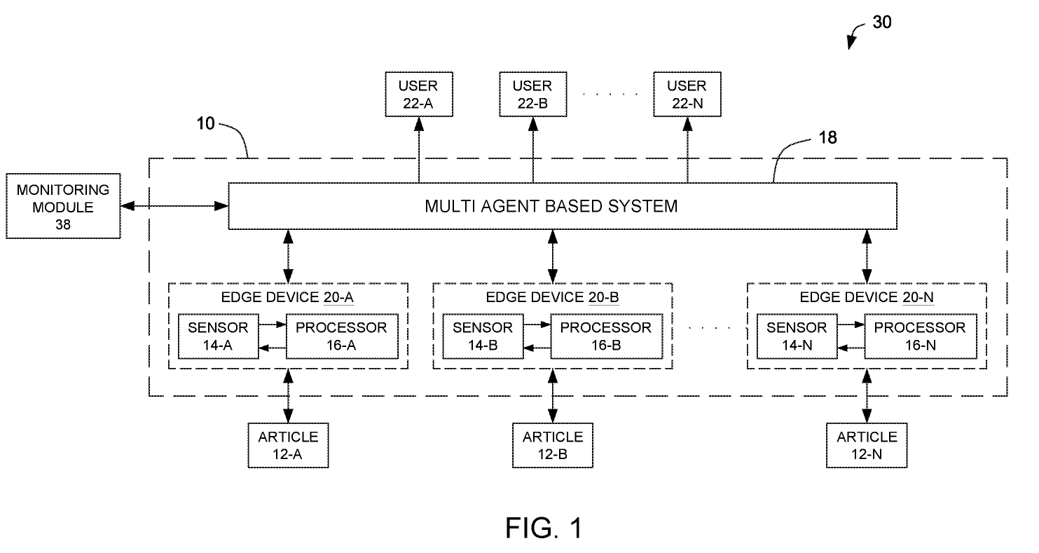

FIG. 1 is a block diagram of one embodiment of an internet of things based analytics system implemented according to aspects of the present technique. The IoT based analytics system 10 is an interconnected system including one or more edge devices 20-A through 20-N and a multi-agent based system 18. Each component is described in further details below.

Edge devices 20-A through 20-N are configured to capture real-time image data of various articles disposed in a customer space 30. As used herein, a customer space refers to physical areas within a business establishment, which is frequented by customers. In one embodiment, the establishment comprises business organizations, retail outlets, retail consumer outlets, casinos, hotels and restaurants, libraries, museums etc. The edge devices 20-A through 20-N comprises sensors 14-A through 14-N and processor 16-A through 16-N. Examples of sensors 14-A through 14-N include small and cost effective sensors like image sensor, audio sensor, heat sensor, location sensors and the like. The sensors 14-A through 14-N act as ‘eyes’ and ‘ears’ of an organization and gather real-time business operational data in a cost effective manner. The sensors 14-A through 14-N capture image data corresponding to the plurality of articles of interest.

Processor 16-A through 16-N are coupled to the corresponding sensors 14-A through 14-N respectively and are configured to identify the articles captured by the sensors. In one embodiment, processor 16-A through 16-N include an agent software abstraction module configured to deploy and manage the intelligence layer on the sensors 14-A through 14-N. In one embodiment, the agents are mobile devices and can be cloned, suspended and scaled across the entire infrastructure in real-time. In particular, the processor 16-A through 16-N generates identification data for the plurality of articles of interest.

Multi-agent based system 18 is configured to receive a set of programmable tasks defined by one or more users 22-A through 22-N. A monitoring module 38 is coupled to the multi-agent based system 18 and is configured to enable a user to monitor a plurality of business parameters for the plurality of articles of interest. As used herein, the term “user” may refer to both natural people and other entities that operate as a “user”. Examples include corporations, organizations, enterprises, managers, teams, or other group of people. In this embodiment, the set of programmable tasks are configured to operate with real time data. Examples of the set of programmable tasks include real time data collected from business operations, object data corresponding to gaming objects, algorithmic trading, fraud detection, demand sensing, payments and cash monitoring, dynamic pricing and yield management, data security monitoring, supply chain optimization and the like.

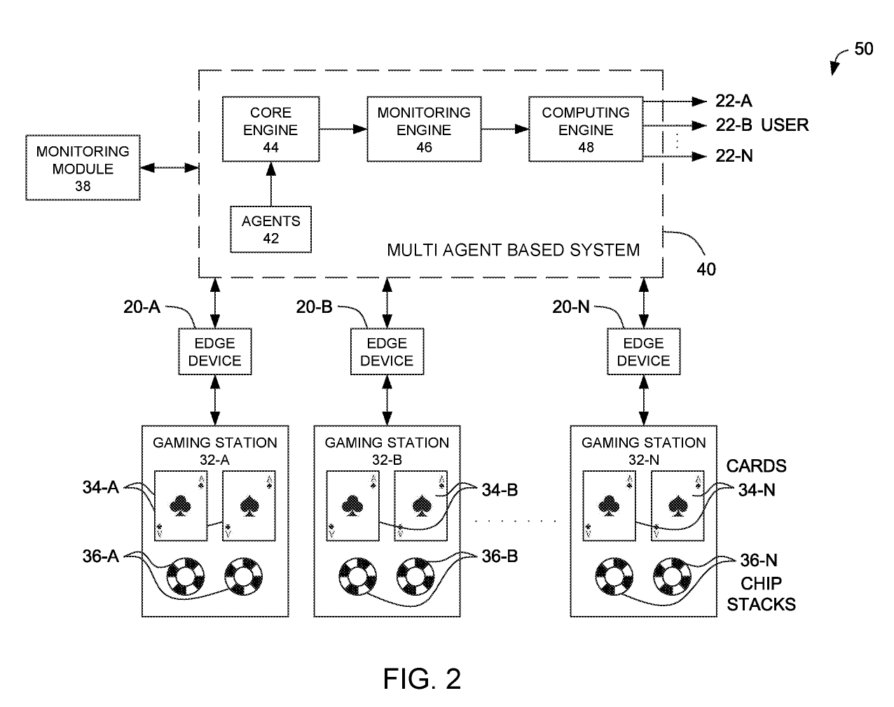

Multi-agent based system 18 comprises agents configured to represent an application defined by one or more users 22-A through 22-N. The agent is further configured to communicate with other agents deployed by the multi-agent based system. Multi-agent based system 18 performs various operations like creating and deploying the agents to perform programmable tasks and monitoring a lifecycle of the agents. In addition, the multi-agent based system 18 is configured to generate a plurality of reports enabling a user to track a plurality of patterns associated with the plurality of articles of interest. The multi-agent based system 18 is described in detail in FIG. 2 below.

FIG. 2 is an example configuration of an internet of things (IoT) based analytics system adapted for use in real-time gaming environment implemented according to aspects of the present technique. The IoT based analytics system 10 is implemented in a real-time gaming environment 50 and includes a multi-agent based system 40 configured to capture data from the gaming stations 32-A through 32-N through the edge devices 20-A through 20-N. Each edge device is disposed adjacent to a corresponding gaming station. Each gaming station comprises a display zone for displaying a plurality of gaming objects. In one embodiment, the gaming station 32-A through 32-N comprises gaming objects which may include one or more playing cards 34-A through 34-N and one or more stacks of betting chips 36-A through 36-N. Each component is described in further detail below.

Multi-agent based system 40 is a real-time agent-based intelligence framework that features properties of intelligence such as perception, memory, correlation, inference, anticipation, reaction, communication and retrospection. The functionality of multi-agent based system 40 is described in detail in India patent application number 3649/CHE/2014 titled “Event Processing Systems and Methods” filed on the 25 Jul. 2014 and is incorporated herein.

In one embodiment, the real-time gaming environment 50 is a casino and the plurality of gaming objects comprise playing cards 34-A through 34-N and stacks of betting chips 36-A through 36-N. In this embodiment, on a casino floor, the deployment of IoT based analytics system 10 can capture real-time data from gaming tables like Blackjack, Poker, Baccarat and the like.

The multi-agent based system 40 includes a plurality of agents 42, a core engine 44, a monitoring engine 46 and a computing engine 48. Core engine 44 is configured to create and deploy agents to perform a set of programmable tasks defined by one or more users 22-A through 22-N. The agents may also be selected from a pre-defined library of agents. Further, the core engine 44 is configured to define a functioning of an agent according to a pre-defined agent behavior. The plurality of agents are configured to perform a set of programmable tasks defined by one or more users. The set of programmable tasks are configured to operate with the object data.

Monitoring engine 46 is coupled to core engine 44 and is configured to monitor a lifecycle of the agents, communication amongst the plurality of agents and a processing time of the programmable tasks. The computing engine 48 is coupled to the monitoring engine 46 and is configured to execute the set of programmable tasks. In particular, the multi-agent based system 40 is configured to determine betting patterns, transactions on the identified chips and cards or combinations thereof. The multi-agent based system 40 further comprises a statistical suite comprising a plurality of statistical tools to process the object data. In one embodiment, the object data comprises image data of the plurality of gaming objects.

Monitoring module 38 is coupled to the multi-agent based system 40 and is configured to enable a user 22-A through 22-N to monitor a plurality of events occurring at each gaming station. The gaming stations 32-A through 32-N are coupled to the edge devices 20-A through 20-N to extract identification data corresponding to the plurality of gaming objects. In one embodiment, each edge device includes a sensor configured to capture object data corresponding to the plurality of gaming objects displayed in the display zone. In addition, each edge device includes a processor coupled to the sensor and configured to generate identification data for the plurality of gaming objects. The processor is configured to determine card suit and a card value of the playing card. In addition, the processor is configured to determine a number of chips played by one or more players at the gaming station.

Moreover, the edge devices are configured to determine a color, a shape and a number on the playing card 34-A through 34-N. The data identified and captured can be further analyzed to generate business insights in real-time. The business insight enables, for example, a gaming floor manager, to respond to dynamic needs of the business like changing number of open gaming tables, changing the distribution of different types of games on the floor and improving dealer efficiency.

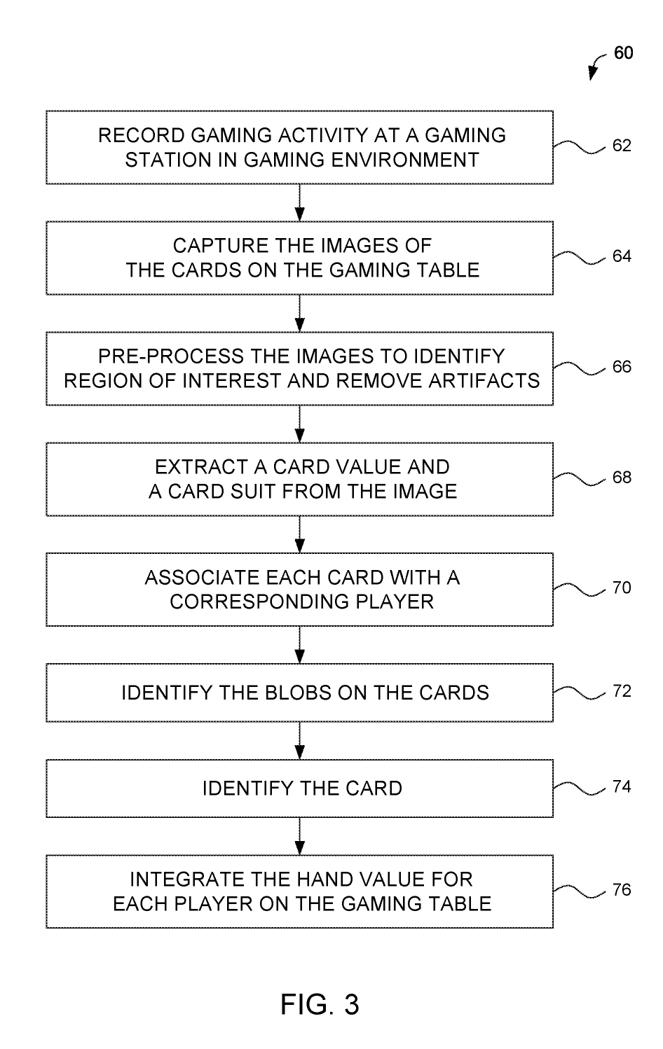

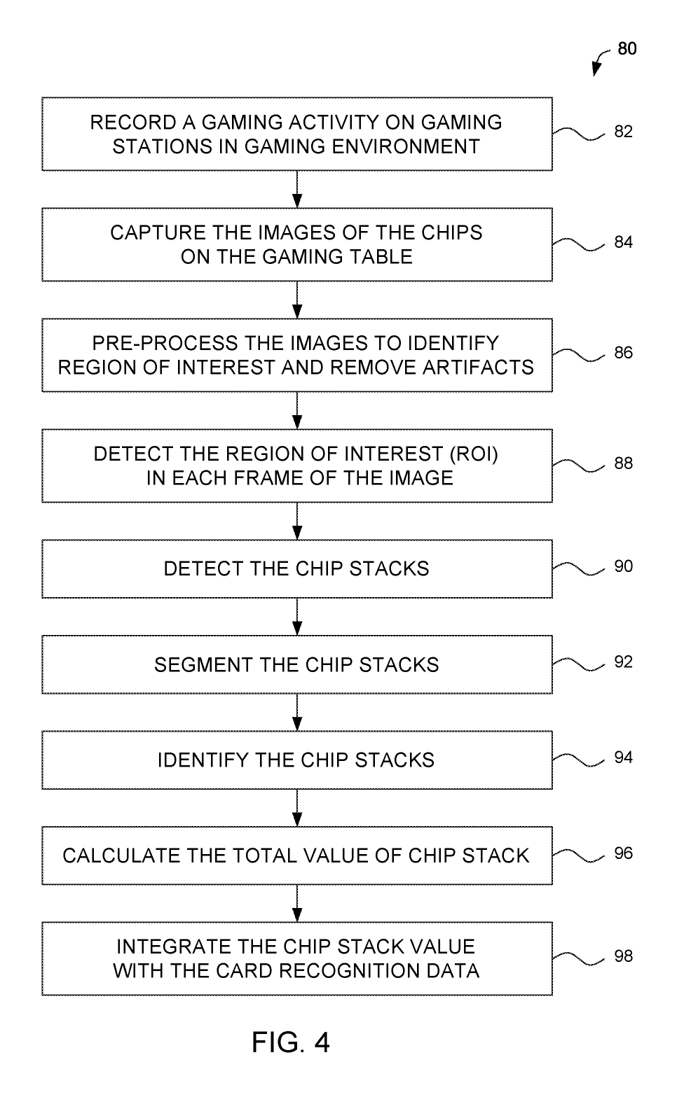

Edge devices 20-A through 20-N are deployed at optimal locations around gaming stations 32-A through 32-N to capture data related to game in progress. The edge devices 20-A through 20-N host and run agents deployed by core engine 44 to identify the playing cards 34-A through 34-N and stacks of betting chips 36-A through 36-N placed on each gaming station. The manner in which the card and chip recognition techniques are implemented is explained in detail in FIG. 3 and FIG. 4 below.

FIG. 3 is a flow chart illustrating one method by which a gaming object such as ‘playing card’ is identified according to aspects of the present techniques. In particular, the process 60 is used to detect, extract and identify playing cards that have been placed on a gaming table. The word ‘card’ and ‘playing card’ used in the description reflects same meaning. Each step is described in further detail below.

At step 62, the gaming activity at a gaming station in a gaming environment is recorded. In this example, the gaming environment is a casino and the gaming station refers to a gaming table where a few players are placing bets on a game of Blackjack. At step 64, the images of the cards on the gaming table are captured. In one embodiment, the video and/or images of the cards are recorded using one or more cameras placed at a non-intrusive location around the table.

At step 66, the images are pre-processed to identify region of interest and remove artifacts. In one embodiment, the Stable Frame Extraction technique is used to select frames that do not include hand movements of the players or the game dealer. The pre-processing step includes separation of the playing cards from the table background. In one embodiment, a strip is defined at the bottom of the gaming table and background subtraction is performed on it. The foreground mask obtained from the above steps is checked for gaming objects. The frame (of a playing card) with a certain threshold level is considered as a stable frame and directed for further processing. The frames below a certain threshold level are rejected and the above steps are repeated.

At step 68, a card value and a card suit is extracted from the image. In this embodiment, a segmentation technique is used to segment and/or extract the card value and the card suit from the image. In one embodiment, the segmentation technique is performed on a test frame and a reference frame. The test frame may or may not have cards. The reference frame is a frame (captured at the time of table initialization), which does not have any cards present. In this embodiment, the reference frame is subtracted from the test frame and the differenced image is considered as a threshold to mark out the card regions.

At step 70, each card is associated with a corresponding player to identify the bets being placed on the table by each player. In one embodiment, a card association technique is used to associate the cards to the corresponding players. In this embodiment, the existing list of contours are collected. For each active player, a player's card is taken. Otherwise, an octagon centered at the betting circle of the player is added to the list of existing contours. For each contour in the set of old contours, the closest new contour/s is/are found. If a player who was previously not active, is associated with a contour, the card contour is added to the player's hand. If an old contour is associated with a single new contour, the distances of the old contour's edges from the new contour's edges is determined. If an old contour is associated with two new contours, a split is assumed to have happened and both the new contours are added to the player's hand. The information resulted from the card association technique is the hand value for the player on the gaming table.

At step 72, the blobs on the cards are identified wherein the blobs represent the area around the card suit and the card value. In one embodiment, the blobs on the cards are identified by filtering the threshold image. The filtering of the threshold image involves removal of noise areas around the blobs which assist in easy identification of the suit. The blobs with area within a predetermined range of the card area are retained and the rest are rejected. In one embodiment, the cards are identified by applying a blob counting process and an optical character recognition (OCR) process.

The blob counting process includes masking the card out of the image and applying a bilateral filtration to the image to remove noise while preserving boundaries. Next, a minimum channel is selected for each channel and is measured using an adaptive thresholding method to convert it into a binary image. Lastly, contour detection technique is performed on the binary image to determine the contours within the card area.

The optical character recognition (OCR) process includes selecting consecutive triplets within a region of interest by iterating the corners of the card contour. Next, the sides are checked against the standard length/breadth of the card. If either length matches, points are picked along the lines at fixed lengths and the region of interest is oriented along a standard card orientation. Lastly, the ROI is then pre-processed and classified by applying a random forest digit classifier. The list of cards are returned, which is then used by the next step.

At step 76, the hand value for each player on the gaming table is integrated with the card value and the card suit. Once this data is determined the chips being played by each player on the gaming table needs to be determined. The identification of chip recognition is described in FIG. 4 below.

FIG. 4 is a flow chart illustrating one method by which the gaming object such as ‘chip’ is identified according to aspects of the present techniques. In particular, the process 80 is used to track the progress of a game and calculate the bets placed by each player during the course of a game. The process 80 identifies the chips (and the value) each player has betted. It may be noted that, the technique is being described with reference to a gaming station in a casino where few players are placing bets on a game of Blackjack. Each step is described in further detail below.

At step 82, a gaming activity on gaming stations in gaming environment is recorded. During the game, players bet by placing chips in the designated areas known as betting circles. The players can also place side bets by placing chips in designated areas for side bets. At step 84, the images of the chips on the gaming table are captured. In one embodiment, the video and/or images of the chips are recorded using a camera placed at a non-intrusive location around the table.

At step 86, the images are pre-processed to identify region of interest and remove artifacts. In this embodiment, the camera used to capture the video and/or image might not be stable and therefore may move intermittently. As a result, the subsequent steps might be at risk. To prevent this, a frame stabilization technique is applied after the receipt of each frame of the captured image and remove artifacts. The frame stabilization technique compares the first frame with each subsequent frame of the image captured, computes the transform similar to auto calibration but using a more lightweight Scale-invariant feature transform (SIFT) instead of affine-SIFT. This triggers every ‘n’ frames of the video and updates the transformation matrix. This matrix is then used to transform every frame that comes from the input source for the next ‘n’.

At step 88, the region of interest (ROI) in each frame of the image is detected. In this embodiment, an auto-calibration technique is used to detect one or more regions of interest (ROI) in the frame. The ROI's are the set of betting circles corresponding to side betting circles for each player. In one example embodiment, the betting circle is the circle with a blue star on it and the side bet circle is the one adjacent to the betting circle. The betting circles and the side betting circles are marked in a reference image. In one embodiment, an Affine-SIFT algorithm is applied on the reference frame to give the precise locations of these circles.

At step 90, the chip stacks are detected. In this embodiment, for each of the player's ROI's a foreground mask is obtained by using an Adaptive Gaussian Mixture Model Background Subtractor (MOG2) technique followed by noise reducing morphological operations. Further, a set of disconnected blobs present in the ROI are obtained. A check is done to identify blobs that satisfies a number of conditions on shape, size, stability, distance, etc. If a blob that satisfies all these conditions is present, then the other blobs are eliminated. The satisfied blob is normalized, reshaped and resized to a normalized size. Further, the parts of the blob with noise are trimmed.

At step 92, the chip stacks are segmented. In this embodiment, the chip segmentation technique takes the previously normalized stack and removes the label of the top-most chip and “flatten” the entire stack out so that the stack would appear like it is being viewed from the side instead of a camera looking down at it. This is performed by identifying the topmost chip of the stack and an ellipse is fitted to the topmost chip and then further cutting that ellipse out. The chip stack is pulled up in an elliptical fashion turning the cylinder into a rectangle. The height of a single chip for this stack is estimated. This is done by making use of the transformation the betting circle has undergone. The values of the major and minor axis give information regarding the angle the camera makes with the table. The angle along with the known height of a chip in real life allows to guess the height of a single chip in the current stack. This height is then used to segment the chips in the stack.

At step 94, the chip stacks are identified. In one embodiment, each chip segment is further divided into 1 pixel high segments and then passed to a classifier. At step 96, the total value of chip stack is calculated. At step 98, the chip stack value is integrated with the card recognition data.

The integrated data from step 98 and step 76 (as described in FIG. 3) is used to calculate the different metrics for all the gaming tables. The integrated data is used to generate the insights for the entire gaming stations in the gaming environment. This data provides recommendations to one or more floor managers to optimize the business metrics. The manner in which the card identification process of FIG. 3 and the chip identification process in FIG. 4 is integrated to provide business recommendations is described in detail below.

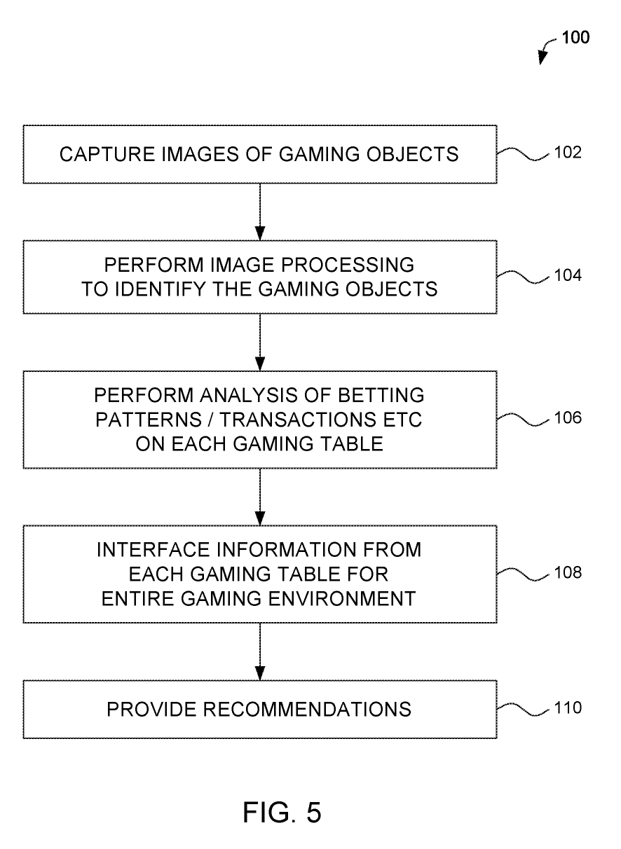

FIG. 5 is a flow chart illustrating one method by which a wide variety of business data is captured, enabled for near-real time decision making in a casino environment based on machine learning and statistical techniques according to aspects of the present techniques. In particular, the process 100 is used for capturing images of gaming objects and provide recommendations to gaming floor manager using an internet of thing (IoT) analytics system 10 described in FIG. 2. Each step is described in further detail below.

At step 102, a plurality of images of gaming objects in the gaming environment are captured. In one embodiment, the gaming environment is a casino and the plurality of gaming objects comprise playing cards 34-A through 34-N and betting chip stacks 36-A through 36-N (as shown in FIG. 2). In this embodiment, on a casino floor, the deployment of IoT analytics system 10 can capture real-time data from gaming tables like Blackjack, Poker, Baccarat and the like. In this embodiment, the edge devices comprising a camera that is placed at a non-intrusive location around the table in the gaming environment is used to capture images.

At step 104, image processing is performed to identify the gaming objects. In this embodiment, the edge devices comprising processors are implemented to identify the gaming objects (for example playing cards 34-A through 34-N and betting chip stacks 36-A through 36-N). FIG. 3 and FIG. 4 describes the image processing on the chip stacks and the playing cards in detail.

At step 106, internet of things (IoT) based analytics is performed to demonstrate the betting patterns and/or transactions on the identified chips and cards placed at the gaming station. In one example embodiment, the internet of things (IoT) based analytics comprises tracking the progress of a blackjack game and calculate the bets placed by each player during the course of a game. The analysis is performed by identifying the chips (and the value) of what each player has bet. During the game, players bet by placing chips in the designated areas known as betting circles. Players can also place side bets by placing chips in designated areas for side bets. Moreover, a suite of statistical algorithms for big data analytics is used for analysis of betting patterns. In addition, customized machine learning algorithms are implemented to analyze the data captured at step 106.

At step 108, the information from each gaming table is interfaced for entire gaming environment. In one embodiment, a web interface is implemented to create, deploy and monitor the gaming information for the entire casino.

At step 110, the recommendations are provided to the gaming managers. In one embodiment, the recommendations are generated based on machine learning and statistical techniques. The recommendations generated are integrated with customized visualization components to enable the gaming managers to make quick business decisions.

The techniques described above are not limited for gaming environments such as casinos. These techniques find applications in a wide variety of businesses. Another example related to the retail sector is described in detail below.

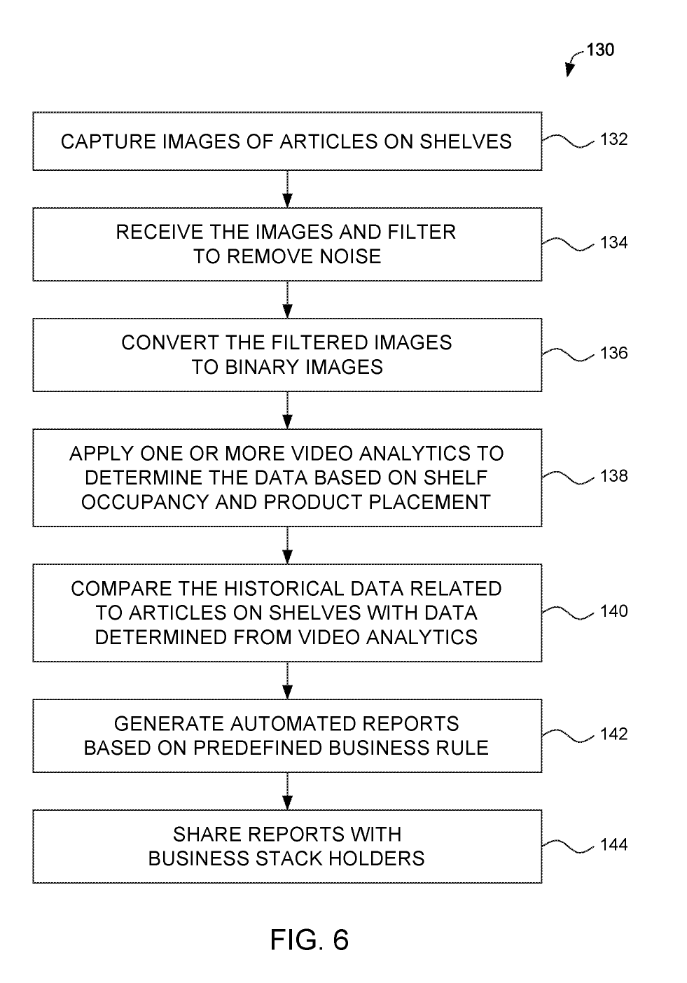

FIG. 6 is a flow chart illustrating one method by which real-time data about product availability from a retail outlet is captured and analyzed, according to aspects of the present techniques. The analysis enables near real-time decision making for retail managers overseeing the outlet. In particular, the process 130 implements an internet of thing (IoT) analytics system 10 for capturing images of articles on shelves in a retail store and provide recommendations to retail manager. Each step is described in further detail below.

At step 132, the images of articles disposed on a plurality of shelves in the retail store are captured. In one embodiment, a camera is placed in a position with a reasonable view of a set of shelves and is configured to capture the images of the articles on the shelves. It may be noted that, the camera is disposed such that there is a reasonable amount of lighting available to capture a clean good quality image. In this embodiment, the image of the articles on the shelves are captured at periodic intervals.

Camera parameters like zoom, aspect ratio etc. may be fixed or may be altered as desired. In this embodiment, an edge device (as described in FIG. 2) is used to capture and beam images of retail shelves. Mobile camera & mobile edge device may also be implemented for the capturing of images of articles on shelves. In one embodiment, the edge device includes a sensor configured to capture object data corresponding to the plurality of articles of interest. For example, the plurality of articles of interest comprises plurality of consumer products disposed on a plurality of shelves in the retail outlet. The object data comprises image data of the plurality of consumer products disposed on the plurality of shelves in the retail outlet.

At step 134, the images are received from the cameras and are filtered to remove noise. In one embodiment, a comparison is performed on the frames to filter out the images which contain noise. At step 136, the filtered images are converted to binary images. The (binary images) processed data is then moved from edge platform to the central repository. In this embodiment, the processor coupled to the sensor is configured to generate identification data for the plurality of articles of interest. In addition, the processor is configured to track the on shelf availability in the retail outlet and identify different product labels present on the shelf.

At step 138, video analytics technique is applied on the processed data to determine the data based on shelf occupancy and product placement. In one embodiment, one or more video analytics techniques like edge detection, contour detection and the like are implemented to determine the shelf occupancy and product placements. At this step, data from several sources like historical data, Point-of-Sale and Planogram are obtained.

At step 140, the historical data related to articles on shelves are compared with the data determined from video analytics. In one embodiment, the images of articles on shelves in a retail store is analyzed to differentiate between products displayed on the shelf. Further, the images can be analyzed to track the on shelf availability in the retail environment and identify different product labels present on the shelf. Also, the images can be analyzed to identify if an individual consumer product is out of stock.

At step 142, automated reports and alerts are generated based on predefined business rules. In one embodiment, a multi-agent based system (as described in FIG. 1 and FIG. 2) is used to receive a set of programmable tasks related to operations in the retail outlet (typically defined by one or more outlet managers, supervisors and the like) and is configured to operate with real-time data that is received from step 142. In one embodiment, the multi-agent based system is configured to determine stock patterns, selling patterns, product restocking data, managing check-out queues by opening new counters, tracking a customer's path inside the retail outlet. Moreover, the multi-agent based system further comprises a statistical suite comprising a plurality of statistical tools to process the object data.

At step 144, the reports and alerts generated are shared with the business stack holders. In one embodiment, the triggered data is a real-time data that enables real-time decision making like restocking a product, managing check-out queues by opening new counters, tracking a customer's path inside the retail store and/or combinations thereof.

For example, the IoT based analytics system provides accurate real-time alerts about stocking levels of each shelves (products preferably). Moreover, the user interface implemented to track the on shelf availability in the retail environment is adaptive and compatible with several platforms such as mobile devices on Android, IOS, Windows mobile 10 and/or combinations thereof. All alerts & reports are supported on desktop and mobile (preferably web based).

In addition, the IoT analytics system 10 includes an on shelf availability feature which is configured to identify out of stock rate and product historical analysis and metrics. The on shelf availability feature also provides retail managers with a dashboard view having real time metrics and charts that capture a store level information. Likewise, on shelf availability feature also provides a scheduler for tasks for the real time update of the requirement and real time alerts of the processes running in the background for the requirement.

This invention has the potential to impact retailers at various economic levels, specifically in improving sales, retail margins, marketing ROI, customer experience, inventory turns and many more. The invention tries to address the concern of business decisions in several types of business organization. Moreover, the invention helps to capture and analyze the real-time data at either cost prohibitive manner, or have an inherent latency which limits the business impact.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated and described herein, many modifications and changes will occur to those skilled in the art. It is, therefore, to be understood that the appended claims are intended to cover all such modifications and changes as fall within the true spirit of the invention.

The aforementioned description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure and appended claims.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one embodiment of the invention relates to a non-transitory computer-readable storage medium comprising electronically readable control information stored thereon, configured in such that when the storage medium is used in a controller of a magnetic resonance device, at least one embodiment of the method is carried out.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An analytics system adapted for use in a real-time gaming environment, the analytics system comprising:
a plurality of gaming stations disposed in a plurality of locations within the gaming environment; each gaming station comprising a display zone for displaying a plurality of gaming objects;
at least one sensor configured to capture object data corresponding to the plurality of gaming objects displayed in the display zone;
at least one processor coupled to the sensor and configured to generate identification data for the plurality of gaming objects;
a multi-agent based system including:
a core engine configured to define and deploy a plurality of agents, the plurality of agents being configured to perform a set of programmable tasks defined by one or more users and the set of programmable tasks being configured to operate with the object data,
a monitoring engine configured to monitor a lifecycle of the plurality of agents, communication amongst the plurality of agents and a processing time of the programmable tasks, and
a computing engine coupled to the core engine and configured to execute the set of programmable tasks; and
a monitoring module coupled to the multi-agent based system and configured to enable a user to monitor a plurality of events occurring at each gaming station.

2. The analytics system of claim 1, wherein the real-time gaming environment is a casino and the plurality of objects comprises playing cards and betting chips.

3. The analytics system of claim 1, wherein the object data comprises image data of the plurality of gaming objects.

4. The analytics system of claim 1, wherein the multi-agent based system is configured to determine betting patterns, transactions on the identified chips and cards or combinations thereofs.

5. The analytics system of claim 1, wherein the processor is configured to determine a card suit and a card value of the playing card.

6. The analytics system of claim 1, wherein the processor is configured to determine a number of chips played by one or more players at the gaming station.

7. The analytics system of claim 1, wherein the multi-agent based system further comprises a statistical suite comprising a plurality of statistical tools to process the object data.

8. An internet of things (IoT) based analytics systems for improving customer experience, the analytics system comprising:
a plurality of articles of interest disposed in a plurality of locations within an establishment;
at least one sensor configured to capture object data corresponding to the plurality of articles of interest;
at least one processor coupled to the sensor and configured to generate identification data for the plurality of articles of interest;
a multi-agent based system including:
a core engine configured to define and deploy a plurality of agents, the plurality of agents being configured to perform a set of programmable tasks defined by one or more users and the set of programmable tasks being configured to operate with the object data,
a monitoring engine configured to monitor a lifecycle of the plurality of agents, communication amongst the plurality of agents and a processing time of the programmable tasks, and
a computing engine coupled to the core engine and configured to execute the set of programmable tasks; and
a monitoring module coupled to the multi-agent based system and configured to enable a user to monitor a plurality of business parameters for the plurality of articles of interest.

9. The internet of things (IoT) based analytics system of claim 8, wherein the multi-agent based system is configured to generate a plurality of reports enabling a user to track a plurality of patterns associated with the plurality of articles of interest.

10. The internet of things (IoT) based analytics system of claim 8, wherein the establishment comprises business organizations, retail outlets, retail consumer outlets, casinos, hotels and restaurants, libraries, museums or combinations thereof.

11. The internet of things (IoT) based analytics system of claim 8, wherein the plurality of articles of interest comprises plurality of consumer products disposed on a plurality of shelves in the retail outlet.

12. The internet of things (IoT) based analytics system of claim 11, wherein the object data comprises image data of the plurality of consumer products disposed on the plurality of shelves in the retail outlet.

13. The internet of things (IoT) based analytics system of claim 8, wherein the multi-agent based system is configured to determine stock patterns, selling patterns, product restocking data, managing check-out queues by opening new counters, tracking a customer's path inside the retail outlet.

14. The internet of things (IoT) based analytics system of claim 11, wherein the processor is configured to track the on shelf availability in the retail outlet and identify different product labels present on the shelf.

15. The internet of things (IoT) based analytics system of claim 8, wherein the multi-agent based system further comprises a statistical suite comprising a plurality of statistical tools to process the object data.
